(19) United States
(12) Patent Application Publication
(10) Pub. No.: US 2023/0278050 A1
(43) Pub. Date: Sep. 7, 2023

(54) FLUID RESERVOIR HAVING AN OPTIONALLY INSERTABLE INNER BAG

(71) Applicant: SATA GmbH & Co. KG, Kornwestheim (DE)

(72) Inventors: Peter DETTLAFF, Remseck (DE); Albrecht KRUSE, Stuttgart (DE)

(73) Assignee: SATA GmbH & Co. KG, Kornwestheim (DE)

(21) Appl. No.: 18/017,933

(22) PCT Filed: Jul. 29, 2021
(86) PCT No.: PCT/EP2021/071253

§ 371 Date: Jan. 25, 2023

(30) Foreign Application Priority Data
Jul. 31, 2020 (DE) 10 2020 120 231.8

(51) Int. Cl. B05B 7/24

(52) U.S. Cl. CPC B05B 7/2408; B05B 7/2478; B05B 7/2481

(57) ABSTRACT

A fluid reservoir for a spray gun, which fluid reservoir has a material outlet configured for the direct and/or indirect connection to the spray gun. The fluid reservoir includes a material container and a cover arrangement for closing the material container in a detachable manner. An inner bag is arranged in the material container and can be filled with coating material. The fluid reservoir is configured in such a manner that it can be filled with coating material optionally with or without the inner bag and can be used for dispensing the coating material via the material outlet to the spray gun. A flow cup arrangement includes a flow cup and an inner bag. The inner bag can be used with different flow cups.

### FIELD OF THE INVENTION

The invention relates to a flow cup for a spray gun, which flow cup has a material outlet that is designed to be directly and/or indirectly connected to the spray gun, wherein the flow cup has a material container and a lid arrangement that detachably closes the material container, wherein an inner bag can be arranged in the material container and can be filled with coating material, wherein the coating material with which the inner bag has been filled can be supplied to the spray gun via the material outlet.

The invention furthermore relates to an inner bag for a flow cup, and to a flow cup arrangement having a flow cup and an inner bag.

### BACKGROUND

A flow cup as described above is known for example from EP 2 027 931 B1, which flow cup has a paint container and a lid that can be mounted onto the paint container. A flow cup comprises an attachment part for connecting the flow cup to a spray gun. EP 2 027 931 B1 mentions a variant in which the flow cup is equipped with a liner (flexible inner bag). As an alternative to the variant with a liner, the document describes embodiments without a liner, and for example with a ventilation valve in the base of the paint container.

Both flow cups that are configured for use with an inner bag and flow cups that are configured for use without an inner bag have their specific advantages depending on the coating task and properties of the coating material. A business, for example a painting business, must consider the range of coating tasks that it performs, and the respective preferences of the users employed by the business, when deciding upon which flow cup system (with or without inner bag) to select. Alternatively, the business may procure both flow cup systems. The business must however then accept double procurement, double stockage etc.

### SUMMARY OF THE INVENTION

One aspect of the invention relates to a flow cup and flow cup arrangement that can be used in a flexible manner.

The flow cup according to the invention is distinguished by the fact it can be filled with coating material, and used so as to dispense the coating material via the material outlet to the spray gun, either with or without the inner bag.

Thanks to the invention, it is no longer necessary or a business to decide upon one type of flow cup in advance, or to procure and stock both types. Immediately before carrying out a coating task, the end user can decide whether to use the flow cup according to the invention with or without an inner bag. This is made possible in particular by the fact that the flow cup according to the invention is fully functional without an inner bag. Said flow cup can be filled with coating material, in particular with paint materials such as finishing paint, clear lacquer, filler etc. Aside from a desired emergence via the material outlet, an emergence of the coating material from the flow cup is avoided, that is to say the flow cup and in particular the wall of the material container is of liquid-tight and solvent-resistant form. In particular, a device is furthermore provided which allows pressure equalization for the interior of the material container when the coating material is dispensed via the material outlet.

Against this background, an exemplary embodiment is particularly preferred in which the flow cup has a ventilation device which comprises at least one ventilation opening via which pressure equalization for the interior of the material container is possible when coating material emerges from the flow cup via the material outlet when the flow cup is used with and without an inner bag. Furthermore, the ventilation device can, at least in one operating state, prevent liquid from emerging from the interior of the material container through the ventilation opening.

For example, the flow cup may be equipped with a ventilation device which permanently prevents fluid (gas and liquid) from being able to escape from the flow cup, but at the same time fluid can enter the interior of the flow cup owing to a generation of a vacuum. For this purpose, the ventilation device has for example a duckbill valve, diaphragm valve etc.

Alternatively, the flow cup may be equipped with a ventilation device which permanently prevents liquid from being able to emerge from the flow cup but which at the same time allows gas to enter. This may preferably be realized through the use of a semipermeable membrane.

In one particularly preferred exemplary embodiment, the ventilation device is a manually actuatable ventilation device or a ventilation valve. The ventilation valve preferably has a closure element that can be moved between an open position and a closed position by the user. This type of construction of a ventilation valve is distinguished by high functional reliability. The ventilation valve may be designed as a rotary valve, tilt valve, disk valve, rotation valve etc.

An embodiment of the flow cup with a ventilation device in the form of a cartridge valve, which is distinguished by particularly high functional reliability and a robust structural form, is particularly preferred.

The ventilation device, in particular the cartridge valve, is particularly advantageously designed such that a closure element, for example in the form of a closure cap, can be installed and uninstalled by the user as required. When the flow cup is used with an inner bag, the closure element is not required. If the flow cup is delivered with a preinstalled closure element, this can be uninstalled before the flow cup is used with an inner bag (for example if the flow cup is designed as an upside-down flow cup with a ventilation device on the container). If the flow cup is delivered without a preinstalled closure element, it is possible for the closure element not to be installed in the first place, if so desired. In both cases, possible fouling or other impairment of the closure element when the flow cup is used with an inner bag is avoided. The closure element can later be used with the flow cup that has already been used without an inner bag, or be used with another flow cup.

The ventilation device is preferably arranged on the lid arrangement of the flow cup, wherein the material outlet is for example provided in an oppositely situated position on the base of the material container.

It is alternatively and likewise preferable for the ventilation device to be provided on the material container and in particular on the base of the material container. In this case, a variant is preferred in which the lid arrangement is equipped with the material outlet.

In a further variant of the flow cup according to the invention, the ventilation device and the material outlet are arranged on the lid arrangement.

In a particularly preferred exemplary embodiment, in order to be able to ensure functionally reliable positioning of the inner bag in the material container without additional retaining means, the detachable connection between material container and lid arrangement is configured such that, when the flow cup is used with an inner bag, the inner bag can be clamped between the material container and the lid arrangement.

Alternatively or in addition, the detachable connection between material container and lid arrangement is configured such that the connection is fluid-tight when the flow cup is used with or without an inner bag. In this way, coating material is reliably prevented from emerging between material container and lid arrangement when work is performed with the flow cup, irrespective of whether an inner bag is used. Furthermore, the fluid-tight form of the connection also makes it possible for coating material to be stored in the flow cup for longer, without drying out or being contaminated by infiltrating substances, for example.

Specifically, the connection between material container and lid arrangement is designed such that the connection is fluid-tight both with an inner bag clamped between material container and lid arrangement and without the inner bag, in which case there is direct contact between the material container and the lid arrangement. In order that the connection is fluid-tight during use without an inner bag, there is consequently no need for a substitute component, for example an annular sealing element, to be used instead of the inner bag.

In a particularly preferred exemplary embodiment, the detachable connection between material container and lid arrangement is (additionally) configured such that the lid arrangement is fastened with a sufficient holding force to the material container when the flow cup is used with and without the inner bag.

A sufficient holding force is for example considered to be a holding force that holds the lid arrangement on the material container when a positive pressure of at least up to 0.2 bar prevails in the interior of the flow cup. Such a positive pressure may arise owing to temperature fluctuations and solvent vapors when coating material is stored in the closed flow cup.

Furthermore, the holding force should be great enough to prevent a release of the connection as a result of pivoting or tilting of the flow cup filled with coating material, which is connected either only via the material container, or via the lid arrangement, to the spray gun.

Preferably, the fluid-tight seal between lid arrangement and material container is realized by means of an axial and/or radial seal when the flow cup is used with inner bag and is realized by means of an axial and/or radial seal when the flow cup is used without inner bag. Specifically, various embodiments are conceivable and technically implementable.

During use with an inner bag, a radial seal may be provided, and during use without an inner bag, an axial seal may be provided. As an alternative to the radial/axial configuration, the connection may be designed so as to yield a radial/radial configuration, an axial/radial configuration or an axial/axial configuration.

Owing to the high functional reliability, an exemplary embodiment is particularly preferred in which the connection is designed such that the fluid-tight seal is realized by means of an axial and radial seal when the flow cup is used with an inner bag and is realized by means of an axial and radial seal when the flow cup is used without an inner bag.

Preferably, “axial” is to be understood to mean a direction along the installation axis along which the lid arrangement and the material container are connected to one another, and “radial” is to be understood to mean a radial orientation in relation to said installation axis. The installation axis generally coincides with the longitudinal axis of the material container and, if said material container is of rotationally symmetrical design, with the axis of rotation thereof. If the lid arrangement is designed as a screw-type lid, the screw axis constitutes the installation axis. If it is for example a snap-on or push-on lid, the installation axis is the axis along which the snap-on or push-on lid is snapped or pushed onto the material container.

Preferably, an axial gap is to be understood to mean a gap between walls that are situated opposite one another in an axial direction, and a radial gap is to be understood to mean a gap between walls that are situated opposite one another in a radial direction.

In a particularly preferred exemplary embodiment, the full functionality of the connection of lid arrangement to material container with and without inner bag is achieved by means of a two-position solution. The connection between lid arrangement and material container is designed such that the lid arrangement and the material container are connected to one another in fluid-tight fashion in a first position if the inner bag is clamped between them and are connected to one another in fluid-tight fashion in a second position if no inner bag is clamped between them. The two positions differ for example in terms of the axial situation and/or the rotational position of lid arrangement and material container with respect to one another.

The two-position solution is preferably designed such that, in the first position, a receiving space for the inner bag is formed between at least one sealing surface on the lid arrangement and a sealing surface on the material container, which sealing surfaces bear directly against one another in the second position, wherein the receiving space is designed such that the inner bag arranged therein serves as a sealing element between the two sealing surfaces. The receiving space is preferably designed as a radial annular gap and/or as an axial annular gap.

In order to realize radial seals in a functionally reliable manner with and without inner bag, a variant of the invention is preferred in which the connection between lid arrangement and material container is designed such that, when the flow cup is used with inner bag, the inner bag is clamped in a radial annular gap between lid arrangement and screw-type lid. When the flow cup is used without inner bag, the lid arrangement and the material container bear radially directly against one another in the region of the radial annular gap.

In a modified exemplary embodiment, when the flow cup is used without inner bag, the lid arrangement and the material container may be spaced apart from one another in the region of the radial annular gap. When the flow cup is used without inner bag, the seal is then realized at a different location (axially and/or radially).

A variant is however particularly preferred in which the lid arrangement and the material container already bear directly against one another in the region of the radial annular gap in the first position, even when no inner bag is used. In this way, during the transition from the first position to the second position, a radial preload, in particular a spreading-open of the material container, is achieved.

In order to realize axial seals in a functionally reliable manner with and without inner bag, a variant of the invention is preferred in which the connection between lid arrangement and material container is designed such that, when the flow cup is used with inner bag, the inner bag is clamped in an axial annular gap between lid arrangement and screw-type lid. When the flow cup is used without inner bag, the lid arrangement and the material container bear axially directly against one another in the region of the axial annular gap.

In a modified exemplary embodiment, when the flow cup is used without inner bag, the lid arrangement and the material container may be spaced apart from one another in the region of the axial annular gap. In this exemplary embodiment, when the flow cup is used without inner bag, the seal is realized at a different location (axially and/or radially).

The inner bag is preferably axially clamped at an encircling edge of the inner bag, which is formed at an open end side of the inner bag. Optional clamping of the inner bag in a radial direction is preferably realized below the edge at a peripheral wall of the inner bag, which peripheral wall extends away from the edge.

Manufacturing-related and stability advantages arise if the lid arrangement is equipped with a receiving groove for an edge region of the material container, wherein a central region of the lid arrangement adjoins the receiving groove.

Owing to the receiving groove, the edge region, connected to the lid arrangement, of the material container (optionally including a part of the inner bag) is enclosed at the inside and at the outside in a stable manner. It is preferably the case that, with and without the use of an inner bag, the seal between lid arrangement and material container is realized on the base of the receiving groove (axial seal) and/or on the outer side of the inner limb of the receiving groove (radial seal).

In a preferred exemplary embodiment, a central region of the lid arrangement is designed as a continuation of at least a predominant part of an inner limb of the receiving groove. The design of the inner limb gives rise to considerable manufacturing-related advantages. Components of flow cups are advantageously produced from plastics material by means of an injection molding process. With regard to the plastics material injection molding process, the variant of the invention is distinguished by the fact that, during the filling of the injection molding tool, the liquid plastics material flow is not split up at the transition from the central region of the lid arrangement to the receiving groove. By means of the invention, the region that is particularly sensitive for the functional reliability of the lid arrangement, specifically the receiving groove, can be formed by a uniform (unbranched) liquid plastics material flow originating from the central region. Fast, uniform and complete filling of the injection molding tool in this particularly critical edge region of the lid arrangement is thus ensured. The cycle times and the wall thicknesses of the lid arrangement can consequently be reduced without loss of function, which in turn leads overall to a saving of costs and materials.

The variant of the invention leads to an increase in functional reliability, or allows a reduction in wall thickness and thus a saving of materials, irrespective of the production method. Since the inner limb of the receiving groove is not of free-standing design but the end thereof is connected to the central region of the lid arrangement, the inner limb is consequently supported or stiffened by the central region, which in turn allows a reduction in the wall thickness whilst achieving the same or even an increased rigidity.

To achieve the manufacturing-related advantages and those arising from stability, the central region need not be attached to the end of the inner limb (although this is particularly preferred). The advantages of the invention are achieved to a lesser but still considerable extent if a predominant part of the inner limb, for example more than 50%, preferably more than 75%, more preferably 95% of the total length of the inner limb (distance from the base of the groove to the outer edge of the inner limb), is designed as a continuation of the central region. This means conversely that less than 50%, preferably less than 25%, more preferably 5%, of the total length of the inner limb is configured as a free-standing or protruding collar, rib, bead, lip etc.

In a particularly preferred embodiment, an annular portion of the central region of the lid arrangement which extends at least approximately perpendicularly with respect to the receiving groove adjoins the receiving groove. This design measure intensifies the discussed effect of the inner limb being supported by the central region.

The at least approximately perpendicular annular portion is preferably followed by an annular portion of the central region which runs at least approximately parallel to the inner limb, specifically such that a further groove is formed, which is however open in the opposite direction in relation to the receiving groove. The further groove forms a compensating ring groove, by way of the dimensioning of which the desired support or rigidity of the inner limb can be defined.

For example, the connection between lid arrangement and material container may be designed as a snap-action or detent connection. In this exemplary embodiment, the possibility of use without a clamped inner bag may be achieved by virtue of the lid arrangement being fixable in two axial detent positions to the material container. In the first detent position, the distance between lid arrangement and material container is great enough that the inner bag can be clamped at least axially between them. In the second position (for use without inner bag), the lid arrangement and the material container bear directly against one another, for example.

A connection which is fluid-tight both with and without a clamped inner bag can be formed in a surprisingly simple and robust manner by virtue of the connection between lid arrangement and material container being designed as a screw connection, in particular as a multi-threaded screw connection.

In a first rotational position, the distance between lid arrangement and material container is great enough that the inner bag can be clamped at least axially between them. In a second rotational position (for use without inner bag), the lid arrangement and the material container bear directly against one another, for example.

Furthermore, an inner bag for a flow cup, and the method for producing same, wherein the inner bag has, at an open end side, an encircling edge from which a peripheral wall leads away, which peripheral wall preferably, at the opposite end side, is closed or has an outlet projection, are considered to be independently inventive.

For example, the edge has a wall thickness that amounts to several times the wall thickness of the peripheral wall. Preferably, the wall thickness of the edge is 0.4 mm to 0.7 mm, in particular approximately 0.5 mm, and the wall thickness of the peripheral wall is 0.1 mm to 0.3 mm, in particular approximately 0.2 mm.

The edge of the inner bag may be equipped with one or more beads, lips, ribs etc. in order to improve the seal when said edge is clamped between the lid arrangement and the material container. Said edge may also have one or more positioning depressions, and/or may be formed with an angled profile.

The inner bag is preferably designed to be rotationally symmetrical with respect to a longitudinal axis that extends along the peripheral wall. Said inner bag preferably has a circular cross section. However, square or other polygonal, elliptical etc. cross-sectional shapes are also conceivable and technically implementable.

The inner bag is preferably a flexibly collapsible inner bag. This is an advantage in particular in conjunction with a flow cup in the form of an upside-down flow cup (material outlet on the lid arrangement) with a ventilation device on the container, because the inner bag, when used in such a flow cup, must contract as coating material emerges.

The inner bag however preferably has sufficient intrinsic rigidity that it nevertheless stands in a stable manner, that is to say does not collapse or buckle in the absence of external forces.

It is self-evident that the inner bag is produced from a fluid-tight, in particular solvent-resistant material, preferably plastics material.

The inner bag is a mass-produced product and is therefore, in a particularly preferred exemplary embodiment, produced in a deep-drawing process.

Alternatively, the inner bag may however be produced in a blow-molding process, in an injection molding process, for example with a hose assembly, by molding of a (plastics material) film under the action of heat and pressure, etc.

In a particularly preferred exemplary embodiment of an inner bag according to the invention, the inner bag is equipped with at least one fold line along which the inner bag preferentially buckles when a vacuum prevails in the interior of the inner bag or when coating material emerges from the interior of said inner bag. The fold line has the effect of reducing the vacuum required for the inner bag to contract.

Alternatively or in addition, the fold line has the effect that the inner bag collapses in such a manner that a smaller residual volume remains in the inner bag, for example between folds of the inner bag, after the collapsing process or after coating material has to the greatest possible extent flowed out of the inner bag.

The inner bag is particularly preferably equipped with at least one fold line that results from shaping and/or weakening of the bag wall along the fold line.

The fold line, or multiple fold lines, may for example be formed immediately during or after the primary forming or molding of the inner bag. For example, if the inner bag is produced in a deep-drawing process, the mold into which the inner bag is drawn or forced may be equipped with a corresponding counterpart mold for forming at least one fold line. This applies analogously to the injection molding tools in the case of an injection molding process.

It is however also conceivable for the inner bag to initially be formed without a fold line and to subsequently be equipped with at least one fold line in a subsequent process step (preferably without reclamping or the like). For this purpose, the inner bag (which is possibly still warmer than a deformation temperature of the plastics material) may for example be subjected to the action of compressed air (which emerges from slots in the deep-drawing mold) or to the action of heat (generated by heating wires, laser irradiation etc.).

The fold line or multiple fold lines may be introduced for example by way of a material variation (by thermal, mechanical or chemical means). For example, the wall thickness of the inner bag may be reduced along the fold line.

The fold line or multiple fold lines may also be introduced by deformation. It is furthermore conceivable for the fold line(s) to arise from regions of the inner bag with different materials (composite inner bag).

The inner bag is preferably equipped with at least one fold line which is annularly closed or which runs in spiral-shaped fashion on the peripheral wall of the inner bag.

In a particularly preferred exemplary embodiment, the inner bag is equipped with multiple annularly closed fold lines which have equal spacings, or spacings which increase or decrease in a longitudinal direction of the inner bag, to one another. The result is preferably a bellows-like or accordion-like inner bag.

In a particularly preferred exemplary embodiment, the inner bag is equipped with criss-crossing fold lines. In particular, a variant of the inner bag is preferred in which the inner bag is equipped with a rhomboidal fold line pattern in the manner of a tubular paper lantern.

In practice, a successful variant of the inner bag according to the invention has proven to be one which, opposite the open end side, is closed with a smooth base or is equipped with a funnel-like outlet projection.

The object mentioned above is also achieved by means of a flow cup arrangement which comprises a flow cup according to one of the exemplary embodiments discussed above and below and an inner bag according to one of the exemplary embodiments discussed above and below, which can be optionally inserted in said flow cup.

In a preferred embodiment of the flow cup arrangement, the flow cup, when used without inner bag, may also be used without a replacement element for the inner bag.

In a particularly preferred exemplary embodiment, the open cup edge of the material container, and that portion of the lid arrangement which interacts therewith, are of conical form, wherein the thickness of the edge of the inner bag, the thickness of the peripheral wall of the inner bag, the conicity of the open cup edge of the material container and the conicity of that portion of the lid arrangement which interacts therewith are coordinated with one another such that a sufficient axial and radial annular gap for receiving the inner bag between the lid arrangement and the material container, and also a fluid-tight seal, are formed during use with the inner bag, and it is nevertheless the case that a fluid-tight seal is likewise formed between the lid arrangement and the material container without an inner bag.

The inner bag, in particular the upper open edge region of the inner bag, is preferably designed such that the inner bag remains in the material container when the flow cup is opened, that is to say is not pulled out of the material container with the lid arrangement. It is thus ensured that the inner bag arranged in the material container can be easily refilled.

In a likewise preferred exemplary embodiment, the inner bag, in particular the upper open edge region of the inner bag, is designed such that, when the lid arrangement is removed from the material container, the inner bag remains suspended on or adhered to the lid arrangement and is removed from the material container. This makes it possible for residual material to be stored in the inner bag that is closed by means of the lid arrangement, without the need to use the material container.

The underlying concept of the invention is however also realized by means of a flow cup arrangement which comprises a replacement element, in particular an annular sealing element, which can be clamped between lid arrangement and material container instead of the inner bag in order for the flow cup to be used without inner bag.

### BRIEF DESCRIPTION OF THE DRAWINGS

The invention will be discussed below on the basis of exemplary embodiments. In the figures:

FIG. 1 shows a sectional illustration of a spray gun with a flow cup arrangement according to a first exemplary embodiment of the invention,

FIG. 2 shows a side view of an optionally insertable inner bag for the flow cup as per FIG. 1,

FIG. 3 shows a side view of an annular sealing element that can be inserted instead of the inner bag as per FIG. 2 in a flow cup as per FIG. 1,

FIG. 4 shows a sectional illustration of a flow cup arrangement according to a second exemplary embodiment of the invention,

FIG. 5 shows a sectional illustration of an optionally insertable inner bag for the flow cup as per FIG. 4,

FIGS. 6 and 7 show an enlarged sectional illustration of the connection of lid arrangement and material container of the flow cup as per FIGS. 1 and 4 with and without inner bag clamped therein, and

FIGS. 8 to 10 show schematic side views for illustrating variants of optionally insertable inner bags for the flow cup as per FIG. 4.

### DETAILED DESCRIPTION

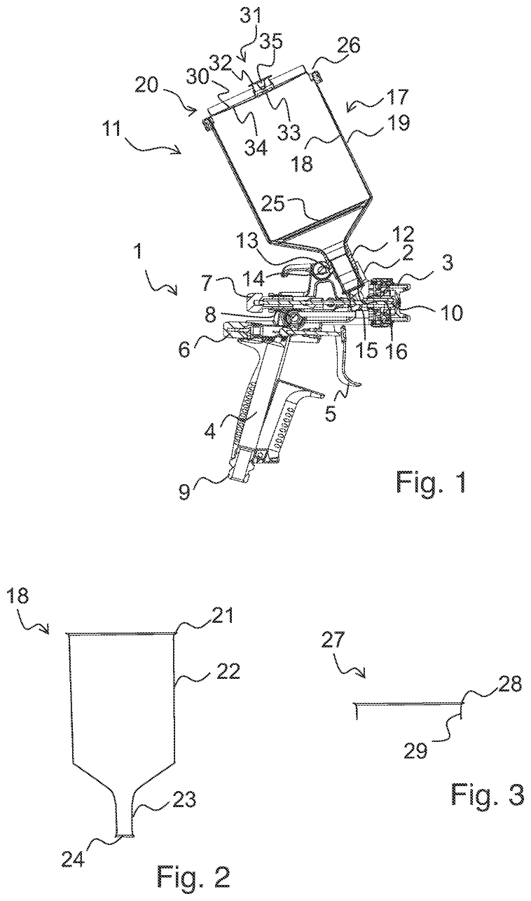

FIG. 1 shows a handheld spray gun 1 for atomizing and applying a flowable coating material with the assistance of compressed air. The spray gun 1 may be configured for example as a so-called high-pressure, compliant or HVLP spray gun 1. The spray gun 1 has a cup attachment 2 and a nozzle head 3, at which coating material supplied to the spray gun 1 via the cup attachment 2 is atomized and emerges in the form of a spray jet.

The spray gun 1 furthermore comprises a handle 4, a trigger 5 for actuating a material needle 10 arranged in the interior of the spray gun 1, a setting mechanism 6 for the stroke of the material needle (material flow rate regulation), an air pressure setting device 7 (micrometer), a round/flat jet setting device 8, and a compressed air attachment 9. The round/flat jet setting device 8 can be used to vary the distribution of the supplied compressed air between, for example, atomizing and transport air, on the one hand, and horn air for forming a flat jet, on the other hand.

A flow cup arrangement 11 is connected by means of a material outlet, in the form of an outlet connector 12, to the cup attachment 2 of the spray gun 1. For this purpose, the outlet connector 12 is equipped with attachment means in the form of a bayonet fastener, which comprise a clamping wedge element 13 that projects radially from the outlet connector 12. The clamping wedge element 13 engages into a corresponding receiving groove 14 on the spray gun 1. The outlet connector 12 seals axially, for example by way of its end surface 15, against the cup attachment 2 (optionally via a clamping ring on the inner bag, FIG. 2) and/or radially by way of two encircling radial sealing lips 16 (scarcely visible in FIG. 1 owing to the proportions).

The flow cup arrangement 11 comprises a flow cup 17 and an inner bag 18 arranged in the flow cup 17. The flow cup 17 has a material container 19, on the base of which the outlet connector 12 is formed. The flow cup 17 furthermore comprises a lid arrangement, in the form of a screw-type lid 20, which closes the material container 19.

FIG. 2 shows the inner bag 18 once again on its own. Said inner bag is produced for example from plastics material in a deep-drawing process.

An edge 21 of the inner bag 18 is clamped between the screw-type lid 20 and the material container 19. A tubular peripheral wall 22, which lines the interior of the material container 19, extends from the edge 21 of the inner bag 18. At the side opposite the edge 21, the peripheral wall 22 transitions into a funnel-shaped outlet projection 23, which is adapted in terms of shape to the material passage of the outlet connector 12 and which lines and is led through said outlet connector. The open end of the outlet projection 23 is equipped with an encircling clamping ring 24, by means of which the outlet projection 23 is fixed to the end surface 15 of the outlet connector 12.

It can be seen from FIG. 1 that a disk-shaped screen element 25 is inserted in the interior of the inner bag 18, through which screen element the coating material must pass before it can exit the inner bag 18 via the outlet connector 12. As an alternative to the disk-shaped screen element 25, a tubular screen element may be used which is inserted into the outlet connector 12 on the cup and/or is inserted into the cup attachment 2 on the gun.

The flow cup 17 as per FIG. 1 is designed as a standard flow cup. It can be filled with coating material either with or without the inner bag 18 and used for dispensing the coating material via the material outlet to the spray gun 1.

This is made possible in particular by virtue of the fact that the detachable connection 26 between material container 19 and screw-type lid 20 is configured such that, when the flow cup 17 is used with inner bag 18, the inner bag 18 is clamped between the material container 19 and the screw-type lid 20, wherein the screw-type lid 20 is fastened with a sufficient holding force to the material container 19 and the connection is fluid-tight. The connection is however additionally firm and fluid-tight even when the flow cup 17 is used without inner bag 18.

FIG. 3 shows an annular sealing element 27 that can be installed between screw-type lid 20 and material container 19 instead of the inner bag 18 in order to ensure that the connection between screw-type lid 20 and material container 19 is fluid-tight even when the inner bag 18 is not used. The sealing element 27 corresponds in terms of shape to the edge portion of the inner bag 18. Said sealing element comprises an identically configured edge 28 and a sealing collar 29, which in FIG. 3 projects downward.

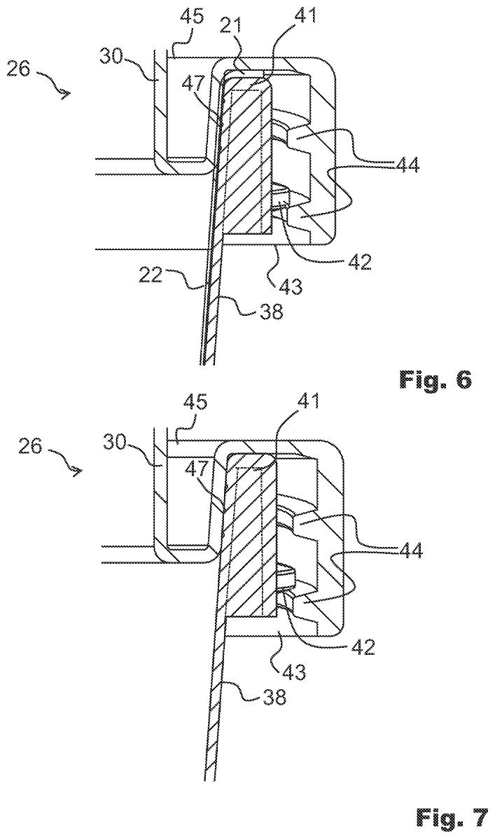

In the case of the flow cup 17 as per FIG. 1, it is however advantageously not necessary to install the annular sealing element 27 during use without inner bag 18, because the screw-type lid 20 and the material container 19 are designed so as to also be connectable directly to one another in fluid-tight fashion. The design of the connection 26 between the screw-type lid 20 and the material container 19 will be discussed in more detail further below on the basis of FIGS. 6 and 7.

It can be seen from FIG. 1 that a central region 30 of the screw-type lid 20 is equipped with a ventilation device. The ventilation device is designed as a cartridge valve 31.

The cartridge valve 31 allows pressure equalization in the interior of the flow cup 17 when coating material flows out of the flow cup 17 via the outlet connector 12 or the outlet projection 23 of the inner bag 18. In the case of this flow cup arrangement 11, it is not necessary for the inner bag 18 to contract when coating material is dispensed to the spray gun 1.

The cartridge valve 31 has a manually actuatable closure element in the form of a closure cap 32, by means of which a ventilation opening 33 in the terminating wall 34 of the screw-type lid 20 can be closed. The closure cap 32 is movable perpendicularly with respect to the terminating wall 34 between an open position and a closed position. In the open position, air can flow through the ventilation opening 33 into the interior of the flow cup 17. In the closed position, a closure plug on the closure cap 32 closes the ventilation opening 33, such that air cannot enter the flow cup 17, nor can coating material emerge from the flow cup 17, via the ventilation opening 33.

The closure cap 32 can be installed or uninstalled by a user in accordance with requirements.

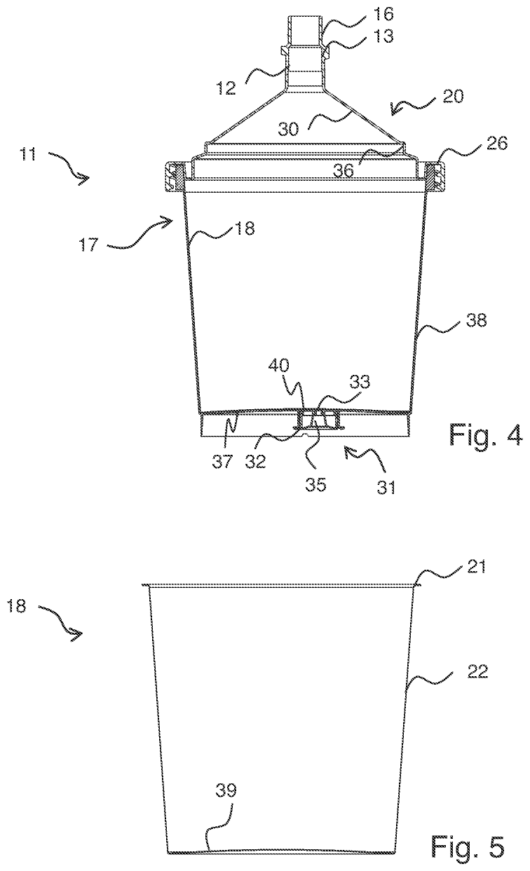

FIG. 4 shows a second exemplary embodiment of a flow cup arrangement 11 with a flow cup 17 and an inner bag 18 arranged therein. Overall, the flow cup 17 according to the second exemplary embodiment is, by contrast to the flow cup 17 as per FIG. 1, designed as an upside-down flow cup. The screw connection 26 between screw-type lid 20 and material container 19, the cartridge valve 31 and the attachment means on the outlet connector 12 are however of identical design to the corresponding components of the flow cup arrangement 11 as per FIG. 1.

By contrast to the first exemplary embodiment, the outlet connector 12 is arranged on the screw-type lid 20, and the cartridge valve 31 is arranged on the base 37 of the material container 19. A screen element receptacle 36 for a flat, disk-like screen element (not shown) similar to the screen element 25 shown in FIG. 1 is provided in the screw-type lid 20. As an alternative to a flat screen element, a tubular plug-in screen may be used which may be fastened in the outlet connector 12 or, on the spray gun, in the cup attachment 2.

FIG. 4 illustrates the cartridge valve 31 in a closed position. Before the flow cup 17 is used with an inner bag 18, the cartridge valve 31 must be opened in order that air can flow into the space between inner bag 18 and material container 19 whilst the inner bag 18 contracts as a result of coating material emerging from the interior thereof. The closure cap 32 of the cartridge valve 31 may also be uninstalled entirely beforehand.

It can be seen from FIG. 4 that the base 37 is, on the inside, substantially smooth with an inward bulge extending uniformly across the entire base 37. This measure is advantageous in particular for unhindered and complete mixing of coating material in the flow cup 17. That point on the inwardly bulged base 37 which projects furthest to the inside owing to the inward bulge has an offset or a depth in relation to the outer edge region of the base 37 of 1% to 4%, more specifically of 2% to 3%, of the diameter of the base 37. In the exemplary embodiment shown, the diameter is for example d=84.6 mm, and the offset is for example V=2.0 mm.

The inwardly bulged base 37 is adjoined by a peripheral wall 38 of the material container 19. The peripheral wall 38 is of conical design, specifically to such an extent that the base 37 (despite the bulge) adjoins the peripheral wall 38 at an angle of greater than 90°. In the exemplary embodiments shown, there is an angle of approximately 92°.

The inner bag 18 is designed analogously, and is shown once again separately in FIG. 5. Like the inner bag 18 as per FIG. 2, the inner bag 18 has an edge 21 by means of which said inner bag can be clamped between the screw-type lid 20 and material container 19. The peripheral wall 22 and the base 39 of the inner bag 18 are designed to replicate the material container 19, such that the inner bag 18, when installed in the interior, substantially fully lines the interior space of the material container 19 and bears closely against the walls of the material container 19. The base 39 of the inner bag 18 is consequently likewise equipped with an inward bulge that extends uniformly across the entire base 39. The peripheral wall 22 widens (slightly) in conical fashion from the base 39 to the edge 21.

The flow cups 17 according to the first and second exemplary embodiments are preferably produced from plastics material in a plastics material injection molding process, wherein the screw-type lids 20 and the material containers 19 are in each case formed as a single piece, aside from the closure cap 32 and the screen elements 25. Alternatively, the components may also be assembled from multiple components, and in particular, the material outlet (outlet connector 12) may be produced as a separate component and inserted into the rest of the lid arrangement or the rest of the material container.

In an exemplary embodiment which is not shown, one or more closure caps and/or one or more screen elements may also be produced as a single piece with the screw-type lid 20 or the material container 19. For example, they may be attached at any desired location by means of tearable webs, lugs, film hinges etc. that can be severed in order for the elements to be installed at some other location.

The material containers 19 are for example produced from polypropylene (PP), and the screw-type lids 20 are for example produced from hard polyethylene or high-density polyethylene (HDPE) or polypropylene (PP). The closure cap 32 is for example likewise produced from hard polyethylene or high-density polyethylene (HDPE) or polypropylene (PP).

The flow cups 17 according to the invention are preferably extremely thin-walled products. For example, the wall thickness of the material container 19 lies in the range from 0.55 mm to 0.65 mm, and is specifically approximately 0.60 mm, and the wall thickness of the screw-type lid 20 lies in the range from 0.50 mm to 0.85 mm, and is specifically 0.60 mm. The only exceptions are material accumulations at local locations, for example for the purposes of forming thread flanks, detent and grip edges, or at the outlet connector 12, in particular for the purposes of forming the clamping wedge element 13.

Preferably, the screw-type lid 20 of the first exemplary embodiment and the material container 19 of the second exemplary embodiment are produced in an injection-molding process in which the gate point of the components is situated in each case as centrally as possible on the inwardly bulged terminating wall (base 37, central region 30). In order to make this possible, the ventilation device is arranged in a slightly eccentric position. Said ventilation device is arranged with an offset with respect to the center of the terminating wall of more than 5% but less than 10% of the diameter of the terminating wall 34.

In FIG. 4, the gate point on the base 37 of the material container 19, which simultaneously corresponds to the location at which the inward bulge is at a maximum, is situated adjacently to the left of the ventilation opening 33 and is denoted by the reference designation 40. In the exemplary embodiment shown, the offset between the eccentric ventilation opening 33 and central gate point 40 is 5.50 mm, which corresponds to 6.50% in the case of a diameter of the base 37 of 84.6 mm.

The screw connection 26 between the screw-type lid 20 and the material container 19 will be described in more detail below on the basis of FIGS. 6 and 7. FIGS. 6 and 7 show an enlarged detail of the structurally identical connecting point both of the flow cup 17 as per FIG. 1 and of the flow cup 17 as per FIG. 4.

FIG. 6 shows the connection 26 with the inner bag 18 clamped therein. The screw-type lid 20 and the material container 19 assume a first rotational position relative to one another. FIG. 7 shows the connection 26 without an inner bag 18 clamped therein. The screw-type lid 20 and the material container 19 assume a second rotational position relative to one another.

The edge region of the material container 19 is equipped with a turned-over portion 41 which is stiffened by means of multiple radial transverse ribs. The transverse ribs end approximately flush with the outer edge of the turned-over portion 41. The turned-over portion 41 has an outer limb, a middle connecting web, and an inner limb. The inner limb transitions into the peripheral wall 38 of the material container 19. FIGS. 6 and 7 show a section through a radial transverse rib that is formed as a single piece with the outer and inner limbs and with the middle connecting web. The dashed lines in FIGS. 6 and 7 indicate the course of the outer and inner limbs and of the middle connecting web. Four thread elements in the form of thread webs 42 are provided on the outer side of the outer limb of the turned-over portion 41.

The edge region of the screw-type lid 20 has a receiving groove 43, which is likewise formed by an outer limb, a middle connecting web, and an inner limb. When the flow cup 17 is in the closed state, the receiving groove 43 encompasses the turned-over portion 41 in the edge region of the material container 19.

In the interior of the receiving groove 43, more specifically on the inner side of the outer limb, there are formed four thread webs 44 which, together with the thread webs 42 on the material container 19, form the multi-threaded screw connection 26. All four thread webs 44 begin approximately at the lower edge of the outer limb and transition into the middle connecting web that forms the base of the receiving groove 43. The thread webs 44 therefore partially overlap in a peripheral direction but are offset axially with respect to one another in the region of overlap.

With a clamped inner bag 18 (FIG. 6), the fluid-tight seal is realized between screw-type lid 20 and material container 19 by way of encirclingly sealing radial and axial contact in the interior of the receiving groove 43. Specifically, the radial seal is realized by virtue of the peripheral wall 22 of the inner bag 18 being clamped in a radial annular gap 48 between the outer side of the inner limb of the receiving groove 43 and the inner side of the inner limb of the turned-over portion 41 of the material container 19.

The axial seal is realized by virtue of the edge 21 of the inner bag 18 being clamped in an axial annular gap 49 between the top side of the middle connecting web of the turned-over portion 41 and the bottom side of the middle connecting web of the receiving groove 43, whereby an end stop for the screw-type closing movement between screw-type lid 20 and material container 19 is also formed. In FIG. 6, the screw-type lid 20 and the material container 19 assume a first position relative to one another defined by said end stop, in which first position the fluid-tight seal and a sufficient holding force between said screw-type lid and material container, in the presence of a clamped inner bag 18, are ensured.

Without a clamped inner bag 18 (FIG. 7), the fluid-tight seal is likewise realized between screw-type lid 20 and material container 19 by way of encirclingly sealing radial contact in the interior of the receiving groove 43. Specifically, the radial seal is realized by virtue of the outer side of the inner limb of the receiving groove 43 and the inner side of the inner limb of the turned-over portion 41 being pressed directly against one another with sealing action.

In the exemplary embodiment shown, an axial seal is additionally realized by virtue of the top side of the middle connecting web of the turned-over portion 41 and the bottom side of the middle connecting web of the receiving groove 43 being pressed sealingly against one another, whereby an end stop for the screw-type closing movement between screw-type lid 20 and material container 19 is also formed. In FIG. 7, the screw-type lid 20 and the material container 19 assume a second position relative to one another defined by said end stop, in which second position the fluid-tight seal and a sufficient holding force between said screw-type lid and material container, without a clamped inner bag 18, are ensured.

An important aspect of the exemplary embodiment shown is that the thickness of the edge 21 of the inner bag 18, the thickness of the peripheral wall 22, the conicity of the upper cup edge of the material container 19 and the conicity of that portion of the screw-type lid 20 which interacts therewith are coordinated with one another such that a sufficient axial 49 and radial annular gap 48 for receiving the inner bag 18 between the screw-type lid 20 and the material container 19, and also a fluid-tight seal, are formed during use with inner bag 18, and it is nevertheless the case that a fluid-tight seal is likewise formed between the screw-type lid 20 and the material container 19 without inner bag 18.

In an exemplary embodiment which is not shown, the additional axial seal may be omitted. In this case, it is for example possible for the top side of the middle connecting web of the turned-over portion 41 to nevertheless come into contact with the bottom side of the middle connecting web of the receiving groove 43 without forming an encirclingly fluid-tight seal, but with the contact still forming an end stop for the screw-type closing movement between screw-type lid 20 and material container 19.

By way of example, FIGS. 6 and 7 show three encircling sealing ribs 47, which are formed on the outer side of the inner limb of the receiving groove 43 and which lead to a further intensification of the sealing action. Furthermore, the sealing action is improved by virtue of the inner diameter of the material container 19 in the upper edge region being selected such that, as the screw-type lid 20 is installed, the material container 19 is spread open at least in the region of the turned-over portion 41, thus resulting in a particularly intense and lasting radial pressing action between the screw-type lid 20 and material container 19, which is further intensified during use with inner bag 18.

It is self-evident that further sealing ribs, lips or beads may alternatively or additionally also be formed at some other location in order to intensify the ceiling action. Alternatively, it is for example also possible for only one axial or only one radial seal to be realized between screw-type lid 20 and material container 19.

The central region 30 of the screw-type lid 20 is designed as a continuation of the inner limb of the receiving groove 43. FIGS. 6 and 7 show only an outer portion of the central region 30. In particular, the inner limb is followed by a first annular portion, which extends at least approximately perpendicularly with respect to the receiving groove 43. The annular portion is followed by a second annular portion which runs at least approximately parallel to the inner limb of the receiving groove 43, specifically such that a compensating ring groove 45 is formed which is open in the opposite direction in relation to the receiving groove 43. For example, manufacturing tolerances of the components can be compensated by means of the compensating ring groove 45, in particular in order to ensure the functionality, strength and sealing action of the screw connection 26. Furthermore, desired support or rigidity of the inner limb of the receiving groove 43 can be defined by way of the dimensioning of the compensating ring groove 45.

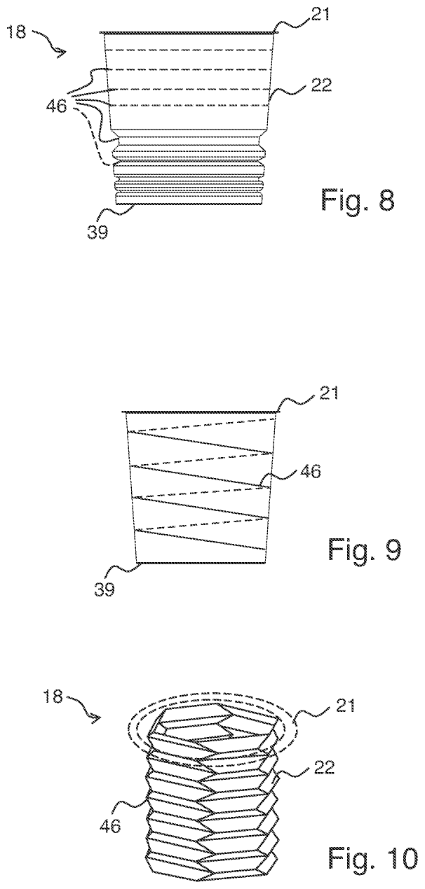

Modified embodiments of the inner bag 18 for the flow cup 17 as per FIG. 4 will be discussed on the basis of FIGS. 8 to 10. The inner bag 18 may advantageously be equipped with at least one fold line 46, owing to which the inner bag 18 contracts, so as to assume a reduced vacuum and/or reduced residual volume, when a vacuum prevails in the interior of said inner bag or coating material emerges from the interior of said inner bag. The fold line 46 or multiple fold lines 46 may be introduced for example by way of a material variation (by thermal, mechanical or chemical means). For example, the wall thickness of the inner bag 18 may be reduced along the fold line 46.

FIG. 8 shows an inner bag 18 equipped with encirclingly closed fold lines 46. By way of example, four fold lines 46 are illustrated which are introduced by means of deformations in the peripheral wall 22, with the specific form of the deformation being slightly different in each case. In preferred variants, multiple fold lines 46 which are however of the same type are provided on an inner bag 18.

In FIG. 8, further fold lines 46 are depicted merely by dashed lines in order to illustrate how fold lines 46 may be provided in a manner distributed along the peripheral wall 22. In the example shown, the fold lines 46 are spaced apart equidistantly. The spacings of the fold lines 46 may however increase or decrease from bottom to top in FIG. 8.

FIG. 9 shows an inner bag 18 equipped, by way of example, with one spiral-shaped fold line 46. Finally, FIG. 10 illustrates a variant of an inner bag 18, the peripheral wall 22 of which is designed as a paper-lantern-like tube owing to criss-crossing rhomboidal fold lines 46. The base (not shown) is for example closed and smooth. The edge 21, connected to the peripheral wall 22, of the inner bag 18 is indicated merely by dashed circles in FIG. 10.

The edges 21 of all inner bags 18 shown have a wall thickness of 0.5 mm to 0.7 mm. The wall thicknesses of the peripheral walls 22 are 0.1 mm to 0.3 mm. All inner bags 18 shown are collapsible in a flexible manner but have sufficient intrinsic rigidity that they nevertheless stand in a stable manner, that is to say do not collapse or buckle in the absence of external forces. The inner bags 18 are produced from a fluid-tight, in particular solvent-resistant plastics material. Preferably, the inner bags are produced from a deep-drawable plastics material film and/or from PE (for example LDPE), PP, PET, a similar plastics material or a mixture of these plastics materials.

Aside from the inner bag 18 as per FIG. 10, all illustrated inner bags 18 are substantially rotationally symmetrical with respect to their longitudinal axis.

The flow cup 17 according to the invention, and the spray gun 1 equipped therewith, are suitable for atomizing and applying a very wide range of different materials. A main field of use is painting in the automobile repair sector, in which finishing paint, filler and clear lacquer are used, and in which the atomization and the properties of the spray jet are subject to very stringent requirements. It is however also possible for numerous other materials to be processed using the flow cup 17 and a possibly modified spray gun 1. It is essential that the materials are flowable and are sprayable at least to a certain extent.

1-23. (canceled)

24. A flow cup for a spray gun, which flow cup has a material outlet that is designed to be directly and/or indirectly connected to the spray gun, wherein the flow cup has a material container and a lid arrangement that detachably closes the material container, wherein an inner bag can be arranged in the material container and can be filled with coating material, wherein the coating material with which the inner bag has been filled can be supplied to the spray gun via the material outlet, wherein the flow cup is designed such that the flow cup can be filled with coating material, and used so as to dispense the coating material via the material outlet to the spray gun, either with or without the inner bag.

25. The flow cup as claimed in claim 24, wherein the flow cup has a ventilation device that can be installed and/or manually actuated by the user, wherein the ventilation device has at least one ventilation opening via which pressure equalization for the interior of the material container is possible when the coating material emerges from the flow cup via the material outlet when the flow cup is used with and without the inner bag, wherein the ventilation device can, at least in one operating state, prevent liquid from emerging from the interior of the material container through the ventilation opening.

26. The flow cup as claimed in claim 24, wherein the flow cup comprises a ventilation device that is arranged on the lid arrangement.

27. The flow cup as claimed in claim 24, wherein the detachable connection between the material container and the lid arrangement is configured such that, when the flow cup is used with the inner bag, the inner bag can be clamped between the material container and the lid arrangement.

28. The flow cup as claimed in claim 24, wherein the detachable connection between the material container and the lid arrangement is configured such that the connection is fluid-tight when the flow cup is used with and without the inner bag.

29. The flow cup as claimed in claim 24, wherein the detachable connection between the material container and the lid arrangement is configured such that the lid arrangement is fastened with a sufficient holding force to the material container when the flow cup is used with and without the inner bag.

30. The flow cup as claimed in claim 24, wherein the fluid-tight seal between the lid arrangement and the material container is realized by means of an axial and/or radial seal when the flow cup is used with the inner bag and is realized by means of an axial and/or radial seal when the flow cup is used without the inner bag.

31. The flow cup as claimed in claim 24, wherein the connection between the lid arrangement and the material container is designed such that the lid arrangement and the material container are connected to one another in fluid-tight fashion in a first position if the inner bag is clamped between the lid arrangement and the material container and are connected to one another in fluid-tight fashion in a second position if no inner bag is clamped between the lid arrangement and the material container.

32. The flow cup as claimed in claim 24, wherein the connection between the lid arrangement and the material container is designed such that, when the flow cup is used with the inner bag, the inner bag is clamped in a radial annular gap between the lid arrangement and the material container, wherein, when the flow cup is used without the inner bag, the lid arrangement and the material container bear radially directly against one another, or are spaced apart from one another, in the region of the radial annular gap.

33. The flow cup as claimed in claim 24, wherein the connection between the lid arrangement and the material container is designed such that, when the flow cup is used with the inner bag, an edge of the inner bag is clamped in an axial annular gap between the lid arrangement and the material container, wherein, when the flow cup is used without the inner bag, the lid arrangement and the material container bear axially directly against one another, or are spaced apart from one another, in the region of the axial annular gap.

34. The flow cup as claimed in claim 24, wherein the lid arrangement is equipped with a receiving groove for an edge region of the material container, wherein a central region, adjoining the receiving groove, of the lid arrangement is designed as a continuation of at least a predominant part of an inner limb of the receiving groove.

35. The flow cup as claimed in claim 24, wherein the lid arrangement is equipped with a receiving groove for an edge region of the material container, which receiving groove is adjoined, radially to the inside, by a compensating ring groove.

36. The flow cup as claimed in claim 24, wherein the connection between lid arrangement and material container is designed as a screw connection.

37. An inner bag for a flow cup, wherein the inner bag has, at an open end side, an encircling edge from which a peripheral wall leads away, which peripheral wall at the opposite end side, is closed or has an outlet projection.

38. The inner bag as claimed in claim 37, wherein the inner bag is produced in a deep-drawing process from plastics material.

39. The inner bag as claimed in claim 37, wherein the inner bag is equipped with at least one fold line, owing to which a vacuum in the interior or an emergence of coating material from the interior of said inner bag causes the inner bag to contract so as to assume a reduced vacuum and/or reduced residual volume.

40. The inner bag as claimed in claim 37, wherein the inner bag is equipped with at least one fold line which results from shaping and/or weakening of the bag wall along the at least one fold line.

41. The inner bag as claimed in claim 37, wherein the inner bag is equipped with at least one fold line which runs in annularly closed or spiral-shaped fashion on the peripheral wall of the inner bag.

42. The inner bag as claimed in claim 37, wherein the inner bag is equipped with multiple annularly closed fold lines which have equal spacings, or spacings which increase or decrease in a longitudinal direction of the inner bag, to one another.

43. The inner bag as claimed in 37, wherein the inner bag is of bellows-like design.

44. The inner bag as claimed in claim 37, wherein the inner bag, opposite the open end side, is closed with a smooth base or is equipped with a funnel-like outlet projection.

45. A flow cup arrangement comprising the flow cup as claimed in claim 24 and an inner bag, wherein the inner bag has, at an open end side, an encircling edge from which a peripheral wall leads away, the peripheral wall at an opposite end side is closed or has an outlet projection.

46. A flow cup arrangement comprising the flow cup as claimed in claim 24, wherein the flow cup arrangement further comprises a replacement element which can be clamped between the lid arrangement and the material container instead of an inner bag in order for the flow cup to be used without an inner bag.
